(19) United States
(12) Patent Application Publication
(10) Pub. No.: US 2015/0228150 A1
(43) Pub. Date: Aug. 13, 2015

(54) CHINESE DOMINO VIDEO WAGERING GAME

(71) Applicant: Konami Gaming, Inc., Las Vegas, NV (US)

(72) Inventors: Hien Thi Thanh Nguyen, Las Vegas, NV (US); Mark Yoseloff, Henderson, NV (US); Ichiro Tsuchida, Zama-shi (JP)

(21) Appl. No.: 14/621,141

(22) Filed: Feb. 12, 2015

Related U.S. Application Data
(60) Provisional application No. 61/939,723, filed on Feb. 13, 2014.

(51) Int. Cl. G07F 17/32; G07F 17/34

(52) U.S. Cl. CPC G07F 17/3213; G07F 17/34

(57) ABSTRACT

In one aspect within the present disclosure, a game machine is provided. The game machine comprises a display and a controller. The display is configured to display a plurality of frames. The controller is configured to: select at least one symbol to display within each frame on the display; determine the presence of a winning combination of symbols between a first set of frames; determine the presence of a winning combination of symbols between a second set of frames; generate a payout amount if a winning combination is determined within the first or second set; and modify the payout amount as a function of the symbol in at least another one of the frames.

### CROSS REFERENCE TO RELATED APPLICATIONS

This application claims the benefit of U.S. Provisional Application No. 61/939,723 titled CHINESE DOMINO VIDEO WAGERING GAME, filed Feb. 13, 2014, the entirety of which is incorporated herein by reference.

### COPYRIGHT NOTICE

A portion of this disclosure contains material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### TECHNICAL FIELD

The present invention relates to gaming machines for the playing of games of chance and, more particularly, to special features of games or feature games which may be offered on such machines.

### BACKGROUND OF THE DISCLOSURE

Gaming machines, such as slot machines, are a cornerstone of the gaming industry. Some known gaming machines include a video display device to display a reel game that includes a plurality of reels, wherein each reel includes a plurality of symbols. During game play, the gaming machine accepts a wager from a player, the player selects one or more paylines, the gaming machine spins the reels, and sequentially stops each reel to display the generated combination of symbols on the reels. The gaming machine then awards the player an award based on the combination of symbols orientated along the selected payline.

Traditionally such machines were mechanical devices where a number of reels marked with a plurality of numbers or symbols could be made to spin randomly by the application of some mechanical input. If the subsequent patterns of numbers or symbols displayed on the reels, when these returned to a rest state, corresponded to predetermined patterns, the machine would provide a prize or payout. Generally such gaming machines have come to be regulated by government authorities as to their number and in the manner in which the machines must return a percentage of the monetary turnover to the players.

The introduction of electronics, computers and electronic graphical displays, has allowed a continual increase in the complexity and variations of gaming machines, games and displays while maintaining the basic concept of the traditional machine. Nevertheless, in some jurisdictions at least, government regulations effectively restrict the degree of variation which may be incorporated in games played on coin-freed machines.

Machines and games therefore that offer novel and stimulating variations on the basic game theme and environment, yet comply with these restrictions are eagerly sought by the gaming industry and there is consequently intense competition between machine manufacturers to innovate.

Games based on simulated rotatable reels typically display a matrix of elements each of which displays a symbol. Predetermined patterns of symbols, if displayed after the reels are spun and come to rest, may then award a prize to the player of the game. Typically also, the symbols are arranged in the elements of a reel so that adjoining elements do not display the same symbol.

Additionally, common sets of symbols have developed in the gaming industry (such as the use of cherries, the number 7, triple 7s, and other commonly used symbols). This common symbol language now allows players to quickly understand the payout rubrics and gameplay of various slot machines. Unfortunately, this regular use of various symbols also limits the variability of gameplay among slot machines and reduces the potential revenue generated by a game machine through decreased interest and gameplay by a player. Also, present machines limit game designers within the industry by providing game machines with game controllers, displays device, and/or network systems that cannot accept new and improved symbols sets and/or pay tables.

It is an object of the present invention to address or at least ameliorate some of the above disadvantages by providing a game machine with a game controller and display device configured utilize and display additional and alternative symbol sets and pay tables based on those symbol sets, thus expanding the revenue-generation potential of the particular game machine.

### SUMMARY OF THE DISCLOSURE

This disclosure provides a game machine. The game machine comprises a display and a controller. The display is configured to display a plurality of frames. The controller is configured to: select at least one symbol to display within each frame on the display; determine the presence of a winning combination of symbols between a first set of frames; determine the presence of a winning combination of symbols between a second set of frames; generate a payout amount if a winning combination is determined within the first or second set; and modify the payout amount as a function of the symbol in at least another one of the frames.

This disclosure also provides a method of playing a game machine is provided. The game machine includes a display and a controller in communication with the display. The display is configured to display a plurality of frames and each frame is configured to display a symbol. The method includes the steps of: selecting, through the controller, at least one symbol to display within each frame on the display; determining, through the controller, the presence of a winning combination of symbols between a first set of frames; determining, through the controller, the presence of a winning combination of symbols between a second set of frames; generating, through the controller, a payout amount if a winning combination is determined within the first or second set; and modifying, through the controller, the payout amount as a function of the symbol in at least one frame outside of the first and second set of frames.

This disclosure also provides a non-transitory information recording medium containing a computer readable program that functions as a game machine is provided. The game machine comprises a display and a controller. The display is configured to display a plurality of frames. The controller is configured to: select at least one symbol to display within each frame on the display; determine the presence of a winning combination of symbols between a first set of frames; determine the presence of a winning combination of symbols between a second set of frames; generate a payout amount if a winning combination is determined within the first or second set; and modify the payout amount as a function of the symbol in at least another one of the frames.

### BRIEF DESCRIPTION OF THE DRAWINGS

Other advantages of the present invention will be readily appreciated as the same becomes better understood by reference to the following detailed description when considered in connection with the accompanying drawings:

FIG. 1 is a perspective view of an exemplary gaming machine;

FIG. 2 is a schematic representation of the gaming machine;

FIG. 3 is a drawing of multiple game machines connected to a progressive jackpot system, according to one industrial embodiment within the present disclosure; and

FIG. 4 is an exemplary graphical display of a game 80 that is displayed by the gaming machine 10 shown in FIG. 1;

FIG. 5 is a showing of portions of adjoining simulated reels according to an embodiment within the present disclosure;

FIG. 6 is a representation of various Pai Gow domino tile pairs utilized in an embodiment within the present disclosure;

FIG. 7 is a representation of additional Pai Gow domino tile pairs according to an embodiment within the present disclosure;

FIG. 8 is another representation of the game 80 according to an embodiment within the present disclosure;

FIG. 9 is another representation of the game 80 according to an embodiment within the present disclosure;

FIG. 10 is a flowchart representation of the method 134 according to an embodiment within the present disclosure;

FIG. 11 is another representation of the game 80 according to an embodiment within the present disclosure;

FIG. 12 is another flowchart representation of the method 134 according to an embodiment within the present disclosure;

FIG. 13 is another flowchart representation of the method 134 according to an embodiment within the present disclosure;

FIG. 14 is a series of representations of the game 80 according to an embodiment within the present disclosure; and

FIG. 15 is another flowchart representation of the method 134 according to an embodiment within the present disclosure.

Corresponding reference characters indicate corresponding parts throughout the drawings.

### DETAILED DESCRIPTION OF THE DISCLOSURE

With reference to the drawings and in operation, the embodiments within the present disclosure overcomes at least some of the disadvantages of known gaming machines by providing a gaming machine and method of providing a game machine that incorporates game play through the use of Chinese domino tiles, also commonly known as Pai Gow tiles. The improvement of the elements within the game machine in the present embodiments (including, but not limited to the game controller, display device, and/or network) allow for game designers to incorporate Chinese domino tiles and the particular mechanics related to their use during gameplay. This creates a game machine that can not only display traditional game symbols and game mechanics but also incorporate additional, improved symbol sets. This will increase the revenue-generation and gameplay potential of a game machine by introducing players to expanded methods of gameplay utilizing Chinese domino tiles as well as attract players with experience with use of Chinese domino tiles in traditional gameplay, such as Pai Gow.

A selected embodiment of the present invention will now be explained with reference to the drawings. It will be apparent to those skilled in the art from this disclosure that the following description of the embodiments of the present invention is provided for illustration only and not for the purpose of limiting the invention as defined by the appended claims and their equivalents.

Referring to the figures, where like numerals generally indicate like or corresponding parts throughout the several views, the systems and methods are constructed in accordance with the invention.

### Gaming Machine

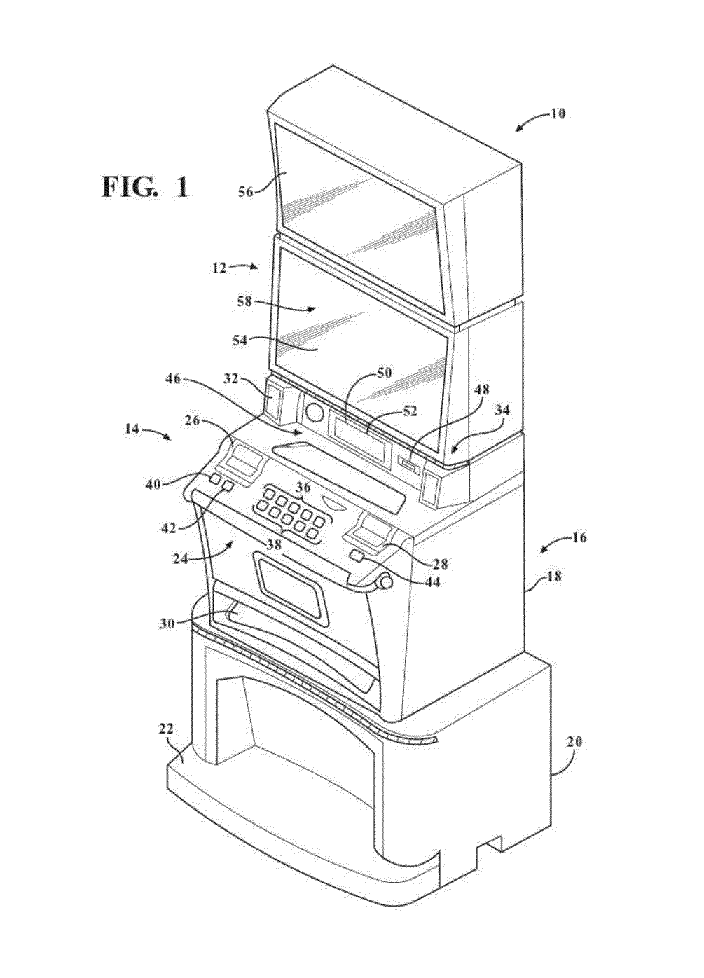

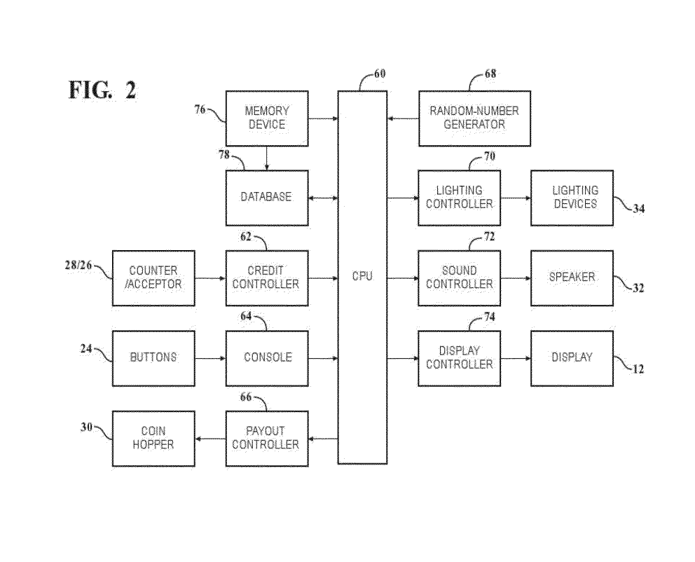

FIG. 1 is a perspective view of an exemplary gaming machine 10. FIG. 2 is a schematic representation of the gaming machine 10. A preferred embodiment of the present invention is a video gaming machine preferably installed in a casino. In the illustrated embodiment, the gaming machine 10 includes a display device 12 for displaying a plurality of games, a user input device 14 to enable a player to interface with the gaming machine 10, and a gaming controller 16 that is operatively coupled to the display device 12 and the user input device 14 to enable a player to play games displayed on the display device 12. The gaming machine 10 also includes a cabinet assembly 18 that is configured to support the display device 12, the user input device 14, and/or the gaming controller 16 from a gaming stand 20 and/or a supporting surface 22.

The display device 12 and the user input device 14 are coupled to the cabinet assembly 18 and are accessible by the player. In one embodiment, the gaming controller 16 is positioned within the cabinet assembly 18. Alternatively, the gaming controller 16 may be separated from the cabinet assembly 18, and connected to components of the gaming machine 10 through a network such as, for example, a local area network (LAN), a wide area network (WAN), dial-in-connections, cable modems, wireless modems, T1, T3, fiber, and/or special high-speed Integrated Services Digital Network (ISDN) lines.

In one embodiment, the user input device 14 includes a plurality of input buttons 24, a coin slot 26, and/or a bill acceptor 28. The coin slot 26 includes an opening that is configured to receive coins and/or tokens deposited by the player into the gaming machine 10. The gaming machine 10 converts a value of the coins and/or tokens to a corresponding amount of gaming credits that are used by the player to wager on games played on the gaming machine 10.

The bill acceptor 28 includes an input and output device that is configured to accept a bill, a ticket, and/or a cash card into the bill acceptor 28 to enable an amount of gaming credits associated with a monetary value of the bills, ticket, and/or cash card to be credited to the gaming machine 10. Moreover, the gaming machine 10 may also utilize a cashless wagering system (not shown), such as a ticket in ticket out (TITO) system (not shown). In one embodiment, the bill acceptor 28 also includes a printer (not shown) that is configured to dispense a printed voucher ticket that includes information indicative of an amount of credits and/or money paid out to the player by the gaming machine 10 during a gaming session. The voucher ticket may be used at other gaming machines, or redeemed for cash, and/or other items as part of a casino cashless system (not shown).

A coin tray 30 is coupled to the cabinet assembly 18 and is configured to receive a plurality of coins that are dispensed from the gaming machine 10. One or more speakers 32 are installed inside the cabinet assembly 18 to generate voice announcements and/or sound effects associated with game play. The gaming machine 10 also includes one or more lighting devices 34 that are configured to blink and/or change brightness and color in specific patterns to produce lighting effects to enhance a visual gaming experience for the player.

In one embodiment, the input buttons 24 include a plurality of BET switches 36 for inputting a wager on a game, a plurality of selection switches 38 for selecting a betting line and/or card, a MAXBET switch 40 for inputting a maximum wager, a PAYOUT switch 42 for ending a gaming session and dispensing accumulated gaming credits to the player, and a start switch, i.e., a SPIN/DEAL button 44 to initiate an output of a game.

In the illustrated embodiment, the BET switches 36 include five switches from 1BET to 5BET to enable a player to wager between a minimum bet up to 5× minimum bet. Each selection switch 38 corresponds to a betting line such as, for example, a payline and/or symbol for a reel game, one or more cards for a card game, and/or a symbol for a roulette game, to enable a player to associate a wager with one or more betting lines. The MAXBET switch 40 enables a player to input the maximum bet that a player can spend against one time of a game. The PAYOUT switch 42 enables a player to receive the amount of money and/or credits awarded to the player during a gaming session, which has been credited onto the gaming machine 10.

The gaming machine 10 may also include a player tracking device 46 that is coupled to the gaming controller 16 for identifying the player and/or a player tracking account that is associated with the player. The player tracking account may include, but is not limited to, gaming credits available to the player for use in playing the gaming machine 10. The player tracking device 46 is configured to communicate player account information between a player tracking controller (not shown) and the gaming machine 10. For example, the player tracking device 46 may be used to track bonus points and/or credits awarded to the player during a gaming session and/or track bonus and/or credits downloaded to the gaming machine 10 from the player tracking system.

The player tracking device 46 is coupled to the gaming cabinet assembly 18 and includes a player identification card reader 48, a data display 50, and a keypad 52. The player identification card reader 48 is configured to accept a player tracking card (not shown) inserted by the player, and read information contained on the player tracking card to identify the player account information. The player identification card reader 48 may include, but is not limited to, a barcode reader, a magnetic card reader, and/or a radio frequency identification (RFID) card reader. The keypad 52 is configured to accept a user selection input such as, for example, a unique player personal identification number (PIN) to facilitate enabling the gaming machine 10 to identify the player, and access player account information associated with the identified player to be displayed on the data display 50. In one embodiment, the data display 50 includes a touchscreen panel that includes the keypad 52. Alternatively, the data display 50 and the keypad 52 may be included in the display device 12.

In one embodiment, the display device 12 includes a first display 54 and a second display 56. The first display 54 is configured to display a game screen 58 including indicia and/or symbols for use in a game, e.g., cards used by a card game, roulette wheel and symbols used in a roulette game, and reels used in a reel game. The game screen 58 may include any type of game including, but not limited to, a video slot game, a keno game, a blackjack game, a video poker game, or any type of game which allows a player to make a wager, play a game, and potentially provide the player an award based on an outcome of the game and a paytable. The second display 56 is configured to display game play instructions for performing the game including, but not limited to, playing instructions, paytables, paylines, betting lines and/or any other information to enable the gaming machine 10 to function as described herein. Moreover, each display 54 and 56 may be configured to display at least a portion of the game screen 58 and/or game play instructions. In one embodiment, the first and second displays 54 and 56 each include a flat panel display, such as a cathode ray tube display (CRT), a liquid crystal display (LCD), a light-emitting diode display (LED), a plasma display, and/or any suitable visual output device capable of displaying graphical data and/or text to a user. Alternatively, a single component, such as a touch screen, may function as both the display device 12 and as the user input device 14. In an alternative embodiment, the first display 54 and/or the second display 56 includes a plurality of mechanical reels displaying a plurality of game symbols.

Referring to FIG. 2, in one embodiment, the gaming controller 16 includes a processor, i.e., a central processing unit (CPU) 60, a credit controller 62, a console unit 64, a payout controller 66, a random-number generator (RNG) 68, a lighting controller 70, a sound controller 72, a display controller 74, a memory device 76, and a database 78. Memory device 76 includes a computer readable medium, such as, without limitation, random access memory (RAM), read-only memory (ROM), erasable programmable read-only memory (EPROM), flash memory, a hard disk drive, a solid state drive, a diskette, a flash drive, a compact disc, a digital video disc, and/or any suitable device that enables the CPU 60 to store, retrieve, and/or execute instructions and/or data.

The CPU 60 executes various programs, and thereby controls other components of the gaming controller 16 according to player instructions and data accepted by the user input device 14. The CPU 60 in particular executes a game program, and thereby conducts a game in accordance with the embodiments described herein. The memory device 76 stores programs and databases used by the CPU 60. Moreover, the memory device 76 stores and retrieves information in the database 78 including, but not limited to, a game type, a number of reels associated with a game, a number of reel strips associated with each reel, a number of symbol positions being displayed on each reel strip, a type of symbols being displayed on each symbol position, a predefined set of normal symbols, a predefined set of special symbols, image data for producing game images and/or screens on the display device 12, and temporarily stores variables, parameters, and the like that are used by the CPU 60. In addition, the memory device 76 stores indicia, symbol weights, pay tables, and/or winning combination tables which represent relationships between combinations of random numbers and types of awards. In one embodiment, the memory device 76 utilizes RAM to temporarily store programs and data necessary for the progress of the game, and EPROM to store, in advance, programs and data for controlling basic operation of the gaming machine 10, such as the booting operation thereof.

Any combination of the components above may be referred to as the “controller” generally in order to execute the game mechanics for which the system is configured as well as to perform the steps described below. Furthermore, additional components may also contribute to the functionality of the “controller” generally as required by the system and method within the further embodiments within this disclosure.

The credit controller 62 manages the amount of player's credits, which is equivalent to the amount of coins and bills counted and validated by the bill acceptor 28. The console unit 64 is coupled to the user input device 14 to monitor player selections received through the input buttons 24, and accept various instructions and data that a player enters through the input buttons 24. The payout controller 66 converts a player's credits to coins, bills, or other monetary data by using the coin tray 30 and/or for use in dispensing a credit voucher via the bill acceptor 28.

The lighting controller 70 controls one or more lighting devices 34 to blink and/or change brightness and color in specific patterns in order to produces lighting effects associated with game play. The sound controller 72 controls the speakers 32 to output voice announcements and sound effects during game play. The display controller 74 controls the display device 12 to display various images on screens preferably by using computer graphics and image data stored in the memory device 76. More specifically, the display controller 74 controls video reels in a game screen displayed on the first display 54 and/or the second display 56 by using computer graphics and the image data.

The RNG 68 generates and outputs random numbers to the CPU 60 preferably at the start of each round of game. The CPU 60 uses the random numbers to determine an outcome of a game. For example, if the game is a video slot game, the CPU 60 uses the RNG 68 to randomly select an arrangement of symbols to be displayed on video reels. Moreover, the CPU 60 generally uses random numbers generated by the RNG 68 to play the games, and to determine whether or not to provide an award to a player. In addition, the CPU 60 generates game outcomes including combinations of random numbers, and compares the generated combinations with winning combinations stored in the winning combination table to determine if the generated outcome is a winning outcome that is associated with a type of award.

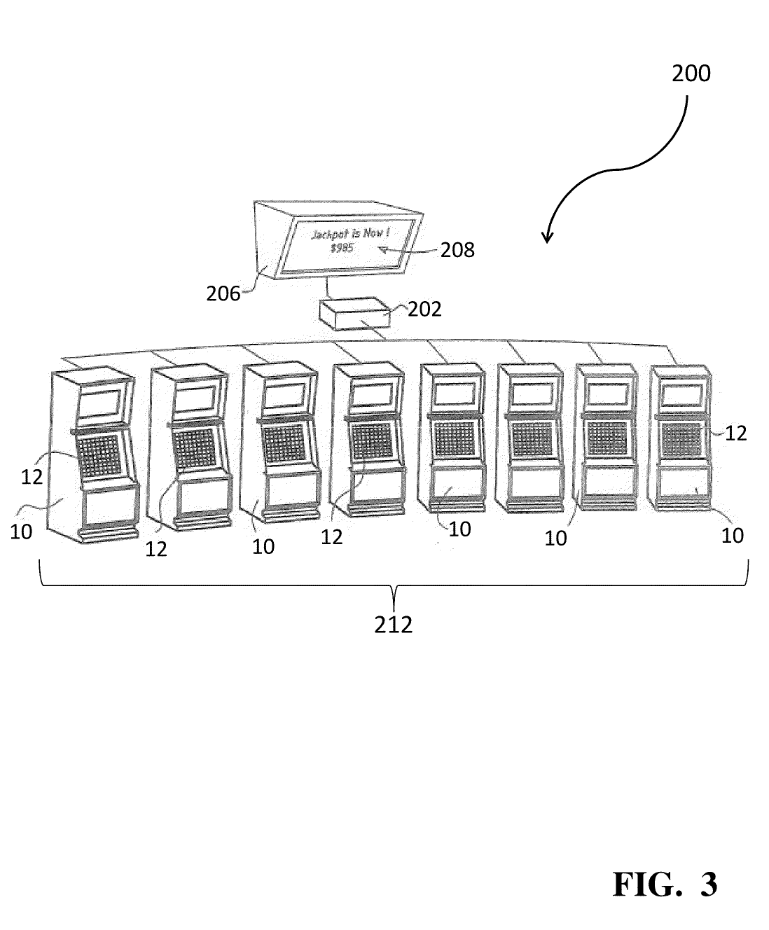

FIG. 3 is a schematic view of an exemplary gaming system 200. The gaming system 200 includes a system controller 202 and one or more gaming terminals 204 coupled to the system controller 202. The gaming system 200 may also include a central display device 206, including a central display 208, coupled to the system controller 202 for displaying games played on one or more of the gaming machines 10. In the illustrated embodiment, the gaming terminal 204 includes the gaming machine 10. In another embodiment, gaming terminal 204 may include a personal computer, laptop, cell phone, smartphone, tablet computer, personal data assistant, and/or any suitable computing device that enables a player to connect to the system controller 202 to play the game 80.

In the illustrated embodiment, the gaming machine 10 and the system controller 202 are in communication with a local area network (LAN) 210. Alternatively, the gaming machine 10 and the system controller 202 may be coupled via a network such as, for example, an Internet link, an intranet, a WAN, dial-in-connections, cable modems, wireless modems, and/or ISDN lines. In the illustrated embodiment, the gaming system 200 includes eight gaming machines 10 arranged in a bank 212, i.e., are arranged together, adjacently. It should be noted, however, that the gaming system 200 may include any number of gaming machines 10 that may be arranged in any manner, such as in a circle or along a curved arc, or positioned within separate areas of a casino floor, and/or separate gaming establishments such as different casinos. Furthermore, additional groups of gaming machines 10 may be coupled to the system controller 202. In one embodiment, the system controller 202 may be implemented by one of the gaming controllers 16 associated with a gaming machine 10. In still another embodiment, the system controller 202 may be located remotely with respect to gaming machine 10, or within one of the gaming machine cabinet assemblies 18 (shown in FIG. 1). The system controller 202 is configured to perform all of the functions of the gaming controller 16 as described herein.

In the illustrated embodiment, the system controller 202 determines if a triggering event occurs in a game outcome being played at one or more of the gaming machines 10, and displays a bonus game such as, for example, the game 80 on the central display 206 if the triggering event occurs. Alternatively, the system controller 202 may display the game 80 at one or more gaming machines 10 based on one or more triggering events occurring in games played at the gaming machine 10. The triggering event may be the appearance of a predefined symbol and/or a predefined symbol combination in a game outcome.

### First Implementation

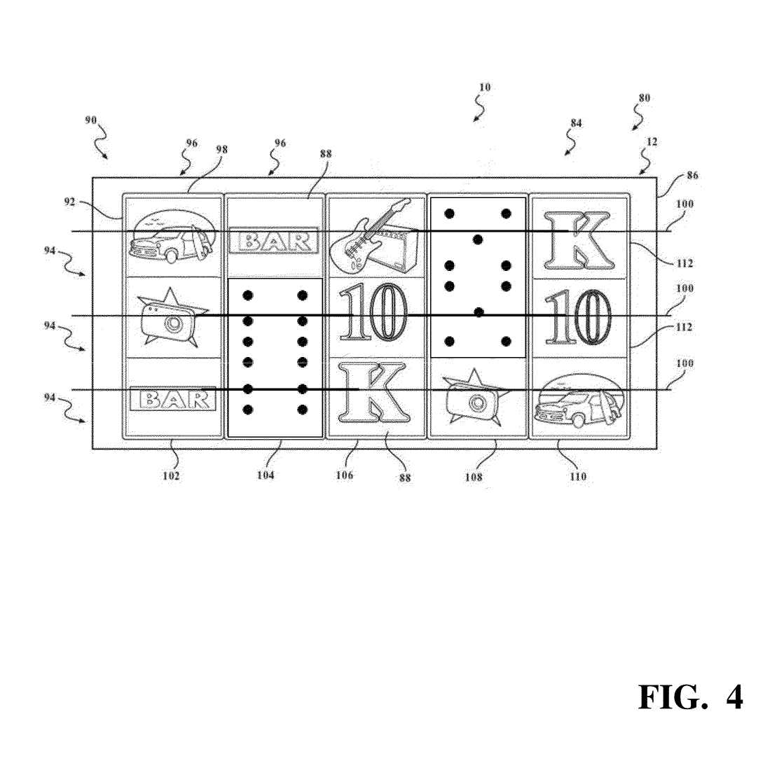

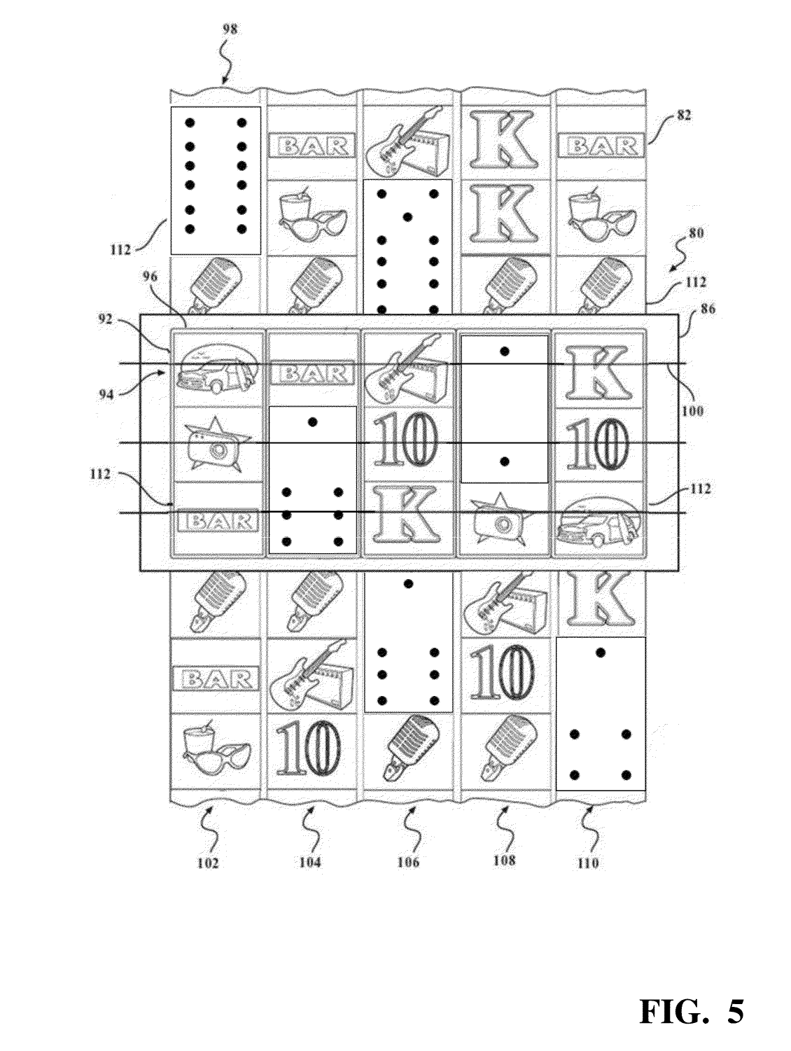

FIG. 4 is an exemplary graphical display of a game 80 that is displayed by the gaming machine 10 shown in FIG. 1. FIG. 5 is a schematic representation of a portion of the gaming machine 10 including the game 80. In the illustrated embodiment, the gaming controller 16 is configured to display the game 80 on the display device 12. In one embodiment, the game 80 is a video slot game. However, it should be noted that the game 80 may be any type of game upon which a player could make a wager including, but not limited to a keno game, a blackjack game, a video poker game, a baccarat game or any type of game that enables the gaming machine 10 to function as described herein. In the illustrated embodiment, the game 80 is displayed on the first display 54. Alternatively, the game 80 may be displayed on the first display 54 and/or the second display 56.

In general, during play of the main game 80, the gaming controller 16 randomly generates an outcome 84 of the main game 80 and displays the generated game outcome 84 in a display area 86. The gaming controller 16 randomly selects a plurality of game symbols 88 from a predefined set of possible game symbols and displays the selected game symbols 88 associated with the generated game outcome 84 in the game display area 86.

In the illustrated embodiment, the plurality of game symbols 88 are displayed in a grid 90 having a plurality of cells 92 arranged along a plurality of rows 94 and a plurality of columns 96. Each cell 92 displays one or more game symbols 88 associated with the game outcome 84. In the illustrated embodiment, the gaming controller 16 displays the game symbols 88 within a plurality of reels 98. Each reel 98 is associated with a corresponding column 96. The main game 80, in one embodiment, includes 5 reels 98 with 3 cells 92 displayed in the display area 86 per reel 98 (a “3×5” arrangement). Alternatively, other reel arrangements may be used such as, for example, 4, 5, 5, 5, and 4 cells per reel, respectively (a “4-5-5-5-4” arrangement), 3-4-3-4-3, or 4-5-4-5-4 arrangements or arrangements with the same number of cells per column, such as 3×3, 3×4, 4×5, 1×4, 1×5 or 5×5 configurations. The main game 80 also includes a plurality of paylines 100 that extend across one or more cells 92 to indicate, to the player, a combination of game symbols 88. The display area 86 may also comprise a payline 100 for arrangements that only have one game symbol 88 displayed within each column 96. In one embodiment, the gaming machine 10 may display the main game 80 via a plurality of mechanical reels (not shown) that include a plurality of symbols displayed on a circumferential surface of each reel.

Each slot game is generally played in a conventional manner. The player makes a wager, which may be based on a predetermined denomination and a selected number of paylines, the gaming controller 16 randomly generates an outcome for the game, spins the reels, and selectively stops the reels to display a game symbol 88 in each of the display cells 92. If a predetermined pattern of symbols 88 is randomly chosen for each cell 92 associated with a played payline 100, the player may be awarded a payout based on the payline, the wager, and a predetermined paytable. Moreover, the player may be awarded a payout if the combination of symbols associated with a selected payline is a winning combination. In addition, a player may receive a bonus feature and/or a bonus game based on the combination of symbols associated with the selected payline and/or the appearance of one or more predefined symbols in the game outcome 84. Many variations to the above described general play of a slot game fall within the scope of the embodiments within the present disclosure. Such slot games are well-known in the art, and are therefore not further discussed.

In the illustrated embodiment, the gaming machine 10 receives a signal, from the user input device 14, that is indicative of a player's selection to initiate a gaming session including a wager amount, and a selection of one or more paylines 100 associated with a predefined set of cells 92 within the displayed grid 90. In the illustrated embodiment, the gaming machine 10 is a multi-line game, i.e., the paylines include horizontal paylines and/or diagonal pay-lines, and/or zig-zag paylines. Moreover, the user input device 14 may allow the player to toggle to increase the bet per payline a credit at a time (up to the maximum bet). The gaming controller 16 randomly generates an outcome of the main game 80, and displays the generated outcome on the display device 12. In one embodiment, the gaming controller 16 is configured to rotate, and/or spin each reel 98 to initiate a game play, and stop each reel 98 to display a plurality of symbols 88 associated with the randomly generated outcome. In addition, the gaming controller 16 is adapted to determine if the generated outcome is a winning outcome based on the displayed game symbols 88, a pay-table, a wager, and one or more selected paylines 100. More specifically, the gaming machine 10 determines if a combination of symbols 88 arranged along the selected payline 100 is a winning combination. The gaming controller 16 may provide an award in response to the outcome of the main game 80. In general, the term “award” may be a payout, in terms of credits or money. Thus, gaming controller 16 may award a regular payout in response to the outcome of the main game 80. However, it should be noted that the term award may also refer to other types of awards, including, prizes, e.g., meals, show tickets, etc. . . . , as well as in-game awards, such as free games or awarding the player one or more wild symbols or stacked wild symbols in each of the games.

The gaming controller 16 is configured to display the game 80 including a plurality of reels 98. For example, in one embodiment, the gaming controller 16 displays the game 80 having five reels 98 orientated horizontally including a 1^{st} reel 102, a 2^{nd} reel 104, a 3^{rd} reel 106, a 4^{th} reel 108, and a 5^{th} reel 110. Each reel 98 may have a plurality of associated reel strips 82 that may be displayed on the respective reel 98. Each reel strip 82 includes a plurality of symbol positions 112. During display of the generated game outcome 84, the gaming controller 16 selects a reel strip 82 to be displayed on at least one of the reels 98, selects a plurality of game symbols 88 being displayed in each of the symbol positions 112 of each selected reel strip 82, and spins each reel 98 such the game symbols 88 are moved through each of the cells 92 in the display area 86.

The gaming controller 16 randomly selects one of the first reel strip 118, the second reel strip, and the third reel strip 122 and displays the selected reel strip 82 with the first reel 102. In addition, the gaming controller 16 may randomly select at least one special symbol 130 from a plurality of special symbols including a predefined set of special symbols 130 and displays the selected special symbol 130 displayed within each special symbol position 114. The gaming controller 16 spins and stops the first reel 102 to display the generated game outcome 84 within the display area 86 including the selected reel strip 82 having the selected special symbol 130 being displayed in each special symbol position 114.

The illustrated embodiment can also include a bonus feature or secondary game in addition to the main game on the gaming machine. The bonus feature or secondary game is an add-on to the main game utilizing any in-game machine asset. A bonus feature or secondary game is considered an add-on to the main game that occurs during game play. The bonus feature or secondary game can used any in-game machine asset that is used to display an award related to the main game. Such awards include free spins, credits, a credit multiplier, or additional pseudo game-play unrelated to the main game. The bonus feature or secondary game can be in any of the wagering or non-wagering formats as described above (slots, video poker, etc.). A bonus feature or secondary game may also be similar to the main game through the use of additional random numbers in order to continue randomized, wager-based game play. A bonus feature or secondary game may include any additional game play and grant awards based on any particularized triggers built into the main game of the game machine. It should be noted that the game may only include the main game 80. Alternatively, the game may include the main game 80 and one or more bonus features and/or one or more secondary games. It should be noted that the present invention is not limited to any specific bonus feature or secondary game (or type thereof).

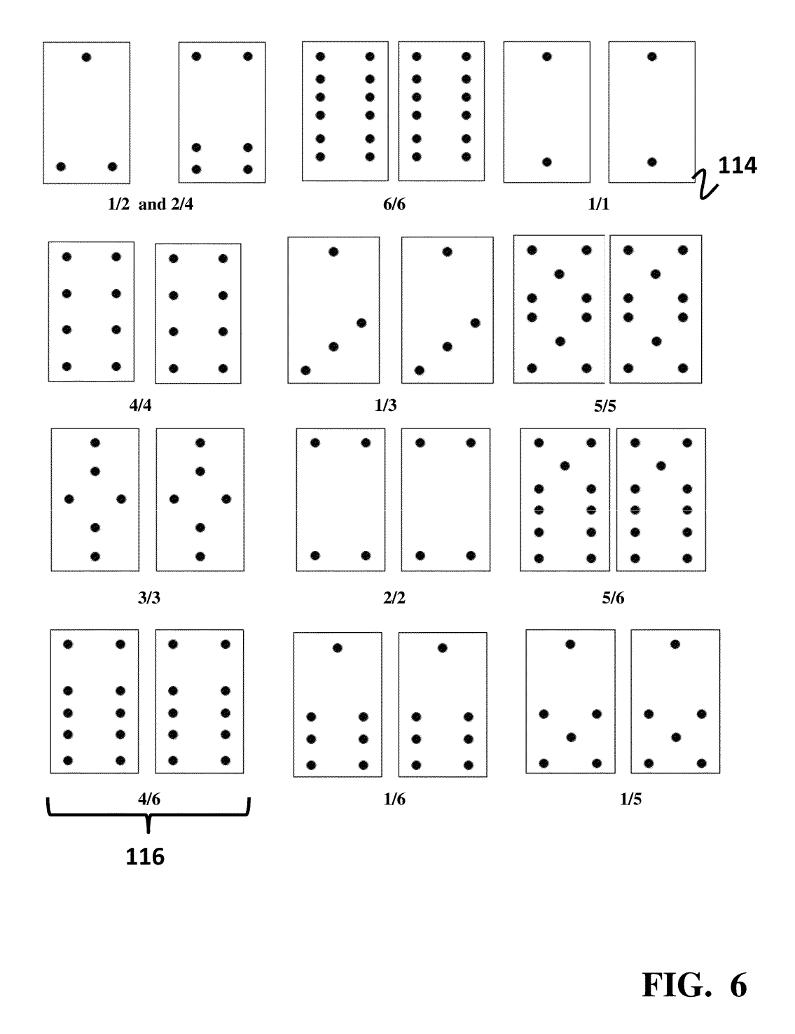

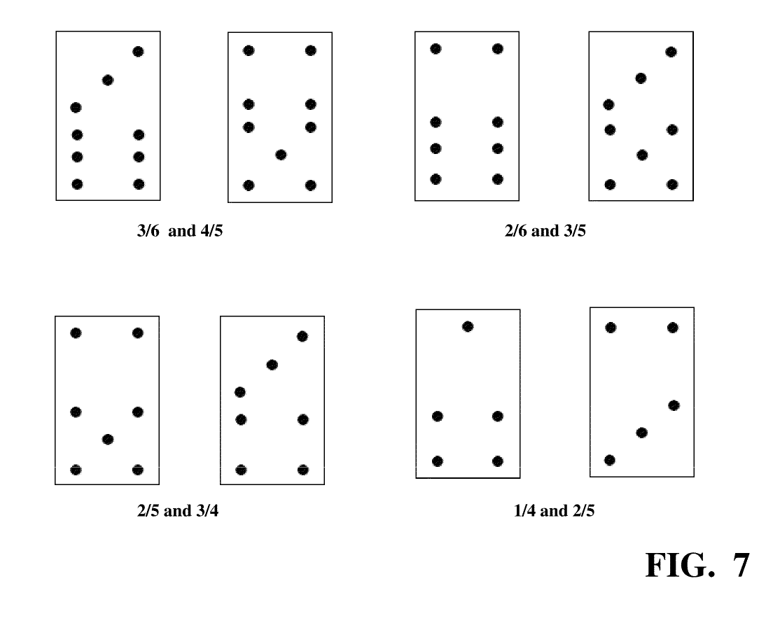

FIGS. 6 and 7 represent various Pai Gow domino tiles 114 that may be used within various embodiments within the present disclosure. Each of the tiles is set up within a particular Pai Gow domino pair 116, which can be utilized within an embodiment in the present disclosure by the game machine 10 during gameplay. The present Pai Gow Tile pairs 116 are only illustrative and additional pairing are also possible depending of the game play requirements of the embodiment that is utilized.

### Second Implementation

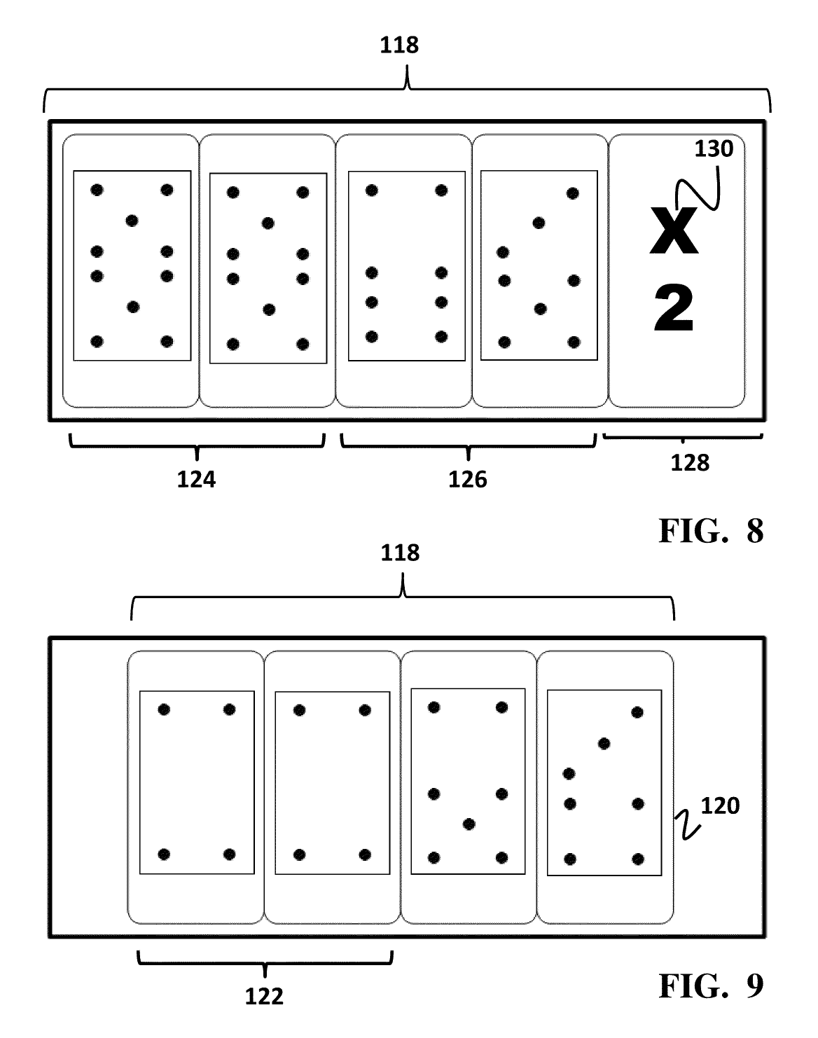

FIG. 8 and FIG. 9 show representations of the game 80 utilizing Pai Gow domino tiles. In this embodiment, the game machine 10 comprises a display device 12 and a gaming controller 16. As shown in both FIG. 8 and FIG. 9, the display device 12 is configured to display a plurality of frames 118. This plurality of frames 118 can vary in number in order to address varying symbol arrangements as discussed above. As shown, FIG. 8 displays a plurality of five frames whereas FIG. 9 demonstrates four frames. More frames may be added for display on the display device 12 and the use of additional frames 120 during gameplay will be discussed in additional embodiments further along within the disclosure. Furthermore, the gaming controller 16 is configured to select at least one game symbol 88 to display within each frame 128 on the display 12. Next, the gaming controller 16 determines the presence of a winning combination 122 of symbols 88 between a first set of frames 124. Next, the gaming controller 16 determines the presence of a winning combination 122 of symbols 88 between a second set of frames 126. Next the gaming controller 16 generates a payout amount if a winning combination is determined within the first set of frames 124 or the second set of frames 126. Finally, the gaming controller 16 modifies the payout amount of the gaming machine as a function of the symbol 88 in at least another one of the frames 120.

FIG. 8 and FIG. 9 show the first set of frames 124 and the second set of frames 126 as adjacent to one another, but this is only for the sake of example and not intended to be deemed a limitation in any way. Both the first set 124 and the second set 126 may be determined as any pair of frames within the plurality of frames 118. The first set 124 and the second set 126 may also be predefined at the start of a game, preset on a machine permanently or randomly determined with each instance within a game session on the game machine 10.

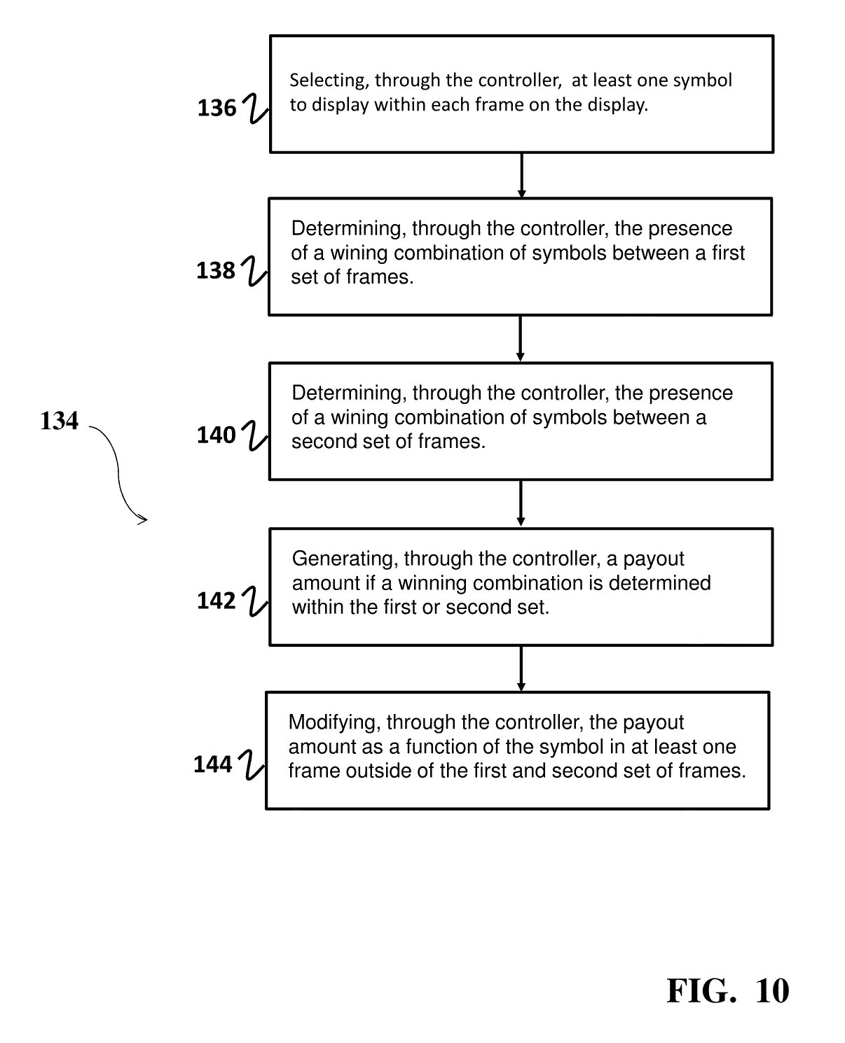

FIG. 10 shows a flowchart of the method 134, which demonstrates a method of playing a game machine 10 including a display device 12 and a gaming controller 16 in communication with the display device 12. The display device 12 is configured to display a plurality of frames 118 and each frame 120 is configured to display a symbol 88. The method 134 begins by selecting 136, through the gaming controller 16, at least one symbol 88 to display within each frame 120 on the display device 12. Selecting the symbol 88 for display within each frame 120 may occur through the random positioning of reels 98 by the gaming controller 16 (as discussed above) within each frame 120 or through random selection of a symbol 88 from the memory device 76 for display through the display device 12. Next, the method 134 determines 138, through the gaming controller 16, the presence of a winning combination 122 of symbols 88 between the first set of frames 124. A winning combination 122 may include one of the pairs 116 of Pai Gow symbols 114 shown within FIGS. 6 and 7, but additional symbol pairs may also be used during gameplay. Next, the gaming controller 16 determines 140 the presence of a winning combination 122 of symbols 88 between a second set of frames 126. Then, the gaming controller 16 generates 142 a payout amount if a winning combination 122 is determined within the first set of frames 124 or second set of frames 126. The payout amount may be determined through the particular Pai Gow pair 116 that is within either set of frames. Finally, the gaming controller 16 modifies 144 the payout amount as a function of the symbol 130 in at least one frame 128 outside of the first set of frames 124 and the second set of frames 126. Variations on the symbol 130 will be discussed in more detail below.

In another embodiment within the present disclosure, a non-transitory information recording medium containing a computer readable program that functions as a game machine 10 is discussed. The non-transitory information medium may include the CPU 60, the memory device 76, and/or the database 78. Furthermore, the non-transitory information medium may also reside within the gaming machine 10, the system controller 202, or within any additional device connected through the local area network 210. In this embodiment, the game machine 10 comprises a display device 12 and a gaming controller 16. As shown in both FIG. 8 and FIG. 9, the display device 12 is configured to display a plurality of frames 118. This plurality of frames 118 can vary in number in order to address varying symbol arrangements as discussed above. As shown, FIG. 8 displays a plurality of five frames whereas FIG. 9 demonstrates four frames. More frames may be added for display on the display device 12 and the use of additional frames 120 during gameplay will be discussed in additional embodiments further along within the disclosure. Furthermore, the gaming controller 16 is configured to select at least one game symbol 88 to display within each frame 128 on the display 12. Next, the gaming controller 16 determines the presence of a winning combination 122 of symbols 88 between a first set of frames 124. Next, the gaming controller 16 determines the presence of a winning combination 122 of symbols 88 between a second set of frames 126. Next the gaming controller 16 generates a payout amount if a winning combination is determined within the first set of frames 124 or the second set of frames 126. Finally, the gaming controller 16 modifies the payout amount of the gaming machine as a function of the symbol 88 in at least another one of the frames 120.

In another embodiment within the present disclosure, the symbols 88 selected for display within the first set of frames 124 are selected from a first predefined group of symbols. This predefined group may include a complete set of Pai Gow domino pairs 116 (as shown in FIGS. 6 and 7), a plurality of game symbols 88 as shown in FIGS. 4 and 5, or any additional symbols or symbol sets used during gameplay. Likewise, this or another embodiment may select the symbols 88 for display within the second set of frames 126 selected from a second predefined group of symbols 88. This predefined group may be a duplicate set of Pai Gow domino pairs 116 as well as any additional symbols 88 as discussed above.

In another embodiment within the present disclosure, the symbols 130 selected for display outside of the first set of frames 124 and/or the second set of frames 126 are selected from a third predefined group. These symbols 130 may be utilized to modify the payout amount of any winning combinations 122 within the first 124 or second 126 set of frames. Such symbols 130 may include payout bonus amounts, multiplier symbols, special bonus prizes, or may also utilize an additional set of Pai Gow domino tiles 114 or symbols 88 in order to modify the payout. The symbol 130 may also be used in conjunction with any of the symbols found with the first 124 and/or second 126 set of frames in order to determine a winning combination within the plurality of frames 118.

In another embodiment, the first predefined group and the second predefined group may be the same. Utilizing the same groups of symbols may involve utilizing the same complete set of Pai Gow domino pairs 116 and/or any additional symbols or symbol sets.

In another embodiment within the present disclosure, the first predefined group is at least one set of Pai Gow domino tiles 114. As shown in FIGS. 6 and 7, the first predefined group may consist of 16 Pai Gow domino pairs 116. Multiple sets of Pai Gow domino tiles 114 may also be used within each set of frames in order to generate additional variability to the gameplay.

In another embodiment, a winning combination is at least one of these pairs of Pai Gow domino tiles 116 (As demonstrated within FIGS. 6 and 7). They include a: 2/4 with a 1/2 tile; 6/6 with a 6/6 tile; 1/1 with a 1/1 tile; 4/4 with a 4/4 tile; 1/3 with a 1/3 tile; 5/5 with a 5/5 tile; 3/3 with a 3/3 tile; 2/2 with a 2/2 tile; 5/6 with a 5/6 tile; 4/6 with a 4/6 tile; 1/6 with a 1/6 tile; 1/5 with a 1/5 tile; 4/5 with a 3/6 tile; 2/6 with a 3/5 tile; 3/4 with a 2/5 tile; or 2/3 with a 1/4 tile.

The pair combinations are identified as number pairs in order to allow for additional variability between the Pai Gow domino tiles 114. Additional elements may be added to the Pai Gow domino tiles 114 in order to further narrow the amount of predefined winning combinations 122. Furthermore, additional tile combinations are availability between the 32 Pai Gow tiles 114 and may be incorporated as predefined winning combinations 122 for gameplay.

### Third Implementation

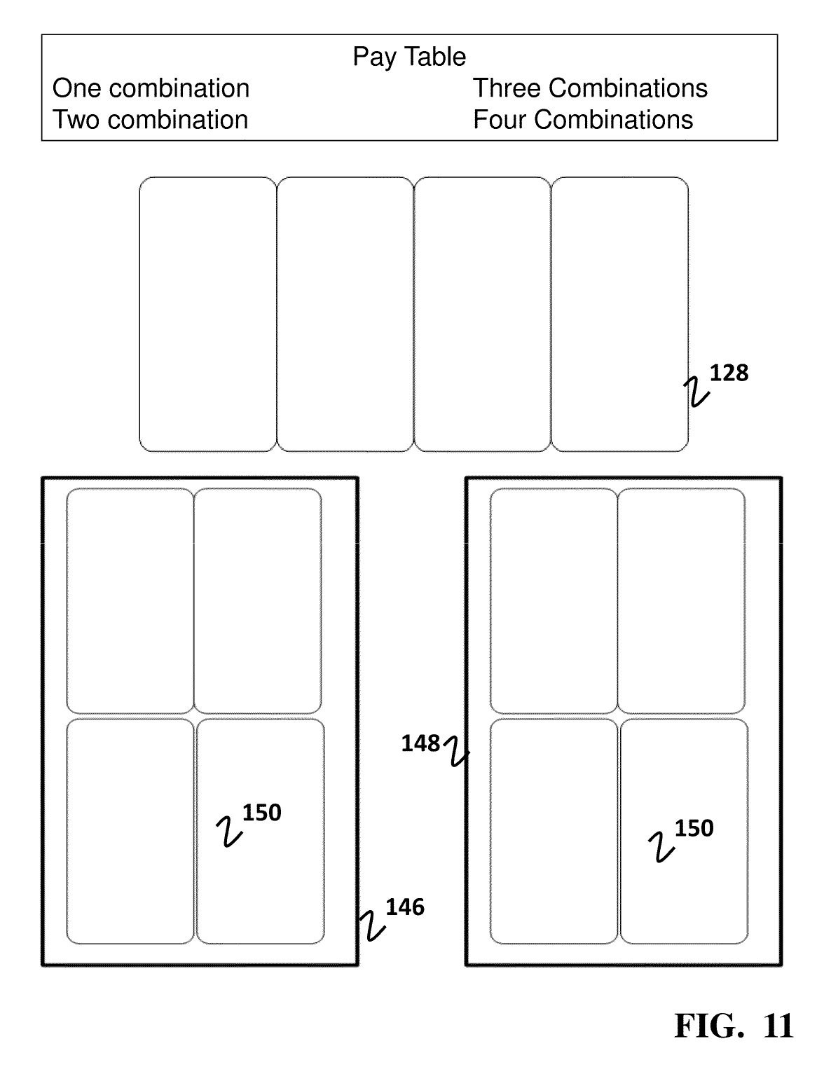

In another embodiment, as shown in the alternate game 80 represented by FIG. 11, the first set of frames 124 and the second set of frames 126 may also comprise a playing field 146. Based on the current display area 86, the gaming controller 16 is configured to display at least two additional sets of frames as a second playing field 148 on the display. Then, the gaming controller 16 determines the presence of a winning combination 122 in either the first set of frames 124 or second set of frames 126 as winning combination 122 within the first playing field 146. Then, the gaming controller 16 determines the presence of a winning combination 122 within either of the two additional set of frames as a winning combination 122 within the second playing field 148. Then the gaming controller 16 generates a payout amount if a winning combination 122 is determined within the first playing field 146 or second playing field 148. Finally, the gaming controller 16 modifies the payout amount as a function of a symbol 130 in at least one other frame 128 outside of the first playing field 146 and the second playing field 148.

This embodiment consolidates the first 124 and second 126 set of frames in order for the gaming controller 16 to determine the presence of a winning combination 122 within a larger set of frames. The presence of a second playing field 148 also allows for greater variability during gameplay by allowing a player to select between playing within only the first playing field 146, the second playing field 148, or both playing fields simultaneously. Also, within this embodiment the at least one frame 128 outside of the first 146 and second 148 playing fields may also include a plurality of frames. These multiple frames may be used in order to further modify the payout from the winning combinations 122 from either or both playing fields during gameplay.

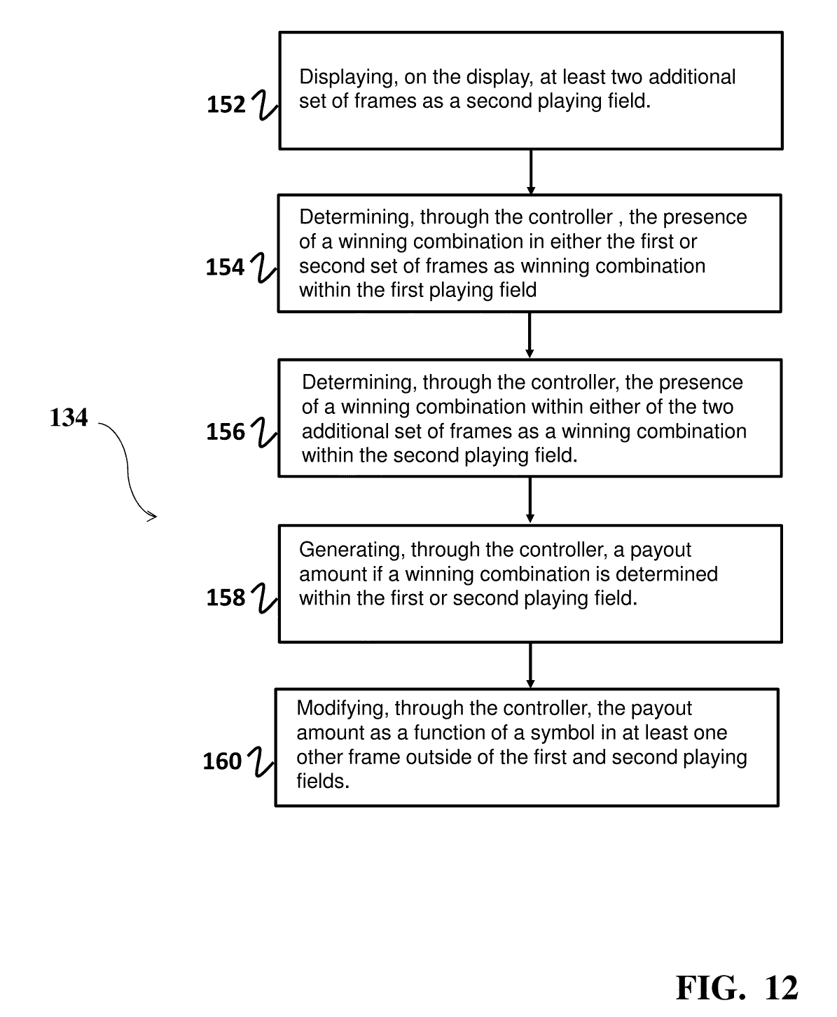

In another embodiment, as shown through a flowchart in FIG. 12, is the method 134 wherein the first 124 and second 126 set of frames further comprise a playing field 146. The method 134 further displays 152, on the display, at least two additional set of frames as a second playing field 148. Then, the gaming controller determines 154 the presence of a winning combination 122 in either the first 124 or second 126 set of frames as winning combination 122 within the first playing field 146. Then the gaming controller 16 determines 156 the presence of a winning combination 122 within either of the two additional set of frames as a winning combination 122 within the second playing field 148. Then, the gaming controller generates 158 a payout amount if a winning combination 122 is determined within the first playing field 146 or second playing field 148. Finally, the gaming controller modifies 160 the payout amount as a function of a symbol in at least one other frame 128 outside of the first playing field 146 and second playing field 148.

In another embodiment, as shown in the alternate game 80 represented by FIG. 11, the first set of frames 124 comprises a first playing field 146 and the second set of frames 126 comprises a second playing field 148. In this embodiment the display device 12 is configured to display at least one additional frame 150 within each playing field. This embodiment differs from the game machine and method embodiments above by allowing a player to add frames to each playing field individually and increase the variability of the Pai Gow domino pairs 116 that would be available within each playing field. First, the gaming controller 16 is configured to determine the presence of a winning combination 122 within the first playing field 146. Then, the gaming controller 16 determines the presence of a winning combination 122 within the second playing field 148. Each playing field now has greater variability of Pai Gow domino pairs 116 as a result of the additional frames within each individual playing field. Then, the gaming controller 16 generates a payout amount if a winning combination is determined within the first playing field 146 or the second playing field 148. Finally, the gaming controller 16 modifies the payout amount as a function of a symbol 130 in at least one other frame 128 outside of the first playing field 146 and the second playing field 148.

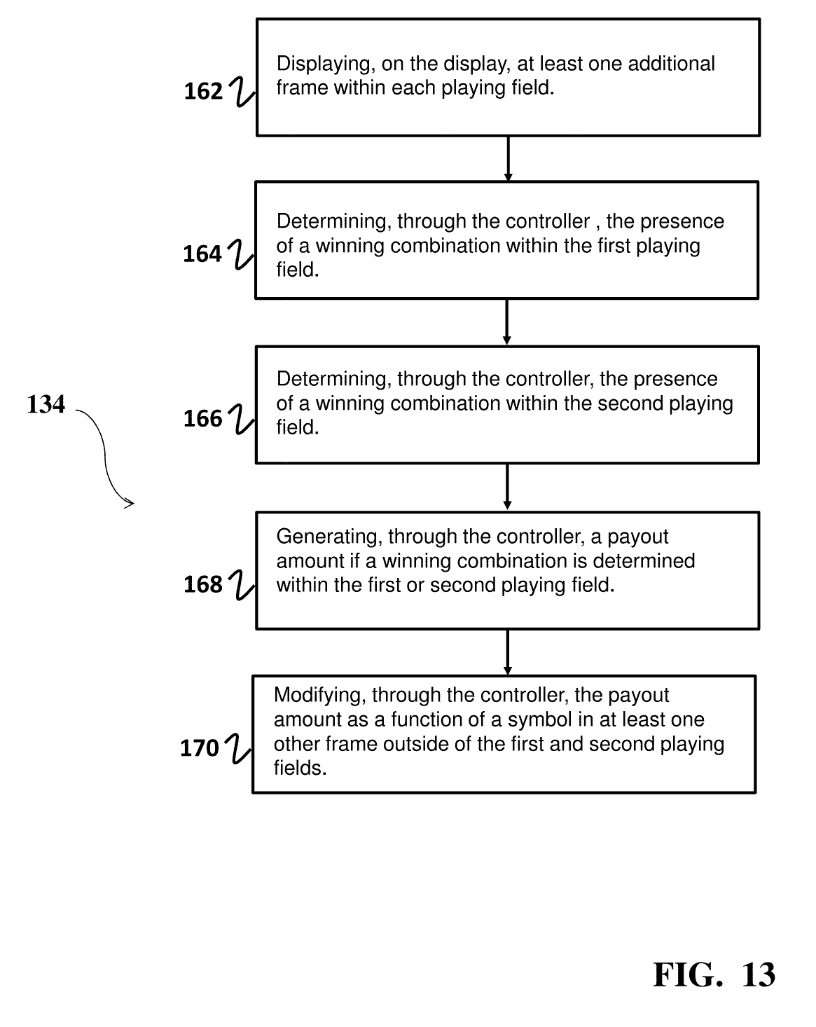

In another embodiment, as shown through a flowchart in FIG. 13, is the method 134 wherein the first set of frames 124 comprises a first playing field 146 and the second set of frames 126 comprises a second playing field 148. The method 134 further displays 162 at least one additional frame 150 within each playing field. Then, the gaming controller determines 164 the presence of a winning combination 122 within the first playing field 146. Then, the gaming controller 16 determines 166 the presence of a winning combination 122 within the second playing field 148. Then the gaming controller generates 168 a payout amount if a winning combination 122 is determined within the first playing field 146 or the second playing field 148. Finally, the gaming controller 16 modifies 170 the payout amount as a function of a symbol 130 in at least one other frame 128 outside of the first playing field 146 and the second playing field 148.

In another embodiment, the modification of the payout amount includes adding to, subtracting from, dividing, and/or multiplying the payout amount. Such modification of the payout may be determined by symbols 130 and may include payout bonus amounts, multiplied amounts, special bonus prizes, or may also utilize an additional set of Pai Gow domino tiles 114 or symbols 88 in order to modify the payout.

In another embodiment, the winning combination 122 consists of a completed image between the frames within either the first set of frames 124 or the second set of frames 126. Additional symbol 88 may be incorporated into the gameplay on the game machine 10 in order to have multiple symbols comprise one image, granting a different payout amount to when all the portions of an image are displayed within a particular set of frames, a particular playing field, or a plurality of frames outside of either a set of frames or a playing field.

In another embodiment, the winning combination 122 consists of a total amount between the frames within the first set of frames 124 or second set of frames 126. The number pairs on each of the Pai Gow domino tiles 114 may be utilized in order to determine additional payout amounts when symbols 120 within the frame set or playing fields do not match a predefined winning combination 122. Furthermore, the total amounts may be utilize in order to further narrow payout amounts between Pai Gow domino pairs 116 that traditionally carry the same weight but have varying total amounts.

In another embodiment, the winning combination 122 consists of corresponding symbols between the frames within the first or second set of frames. As discussed above, FIGS. 6 and 7 demonstrate corresponding pairs of symbols as predefined winning combinations 122 during gameplay. Additional corresponding pairs may also predefined for use during gameplay depending on the desires level of variability by the owner of the game machine 10. Furthermore, other embodiments may include winning combination 122 with corresponding colors between the frames within the first set of frames 124 or the second set of frames 126. It should be notes that additional audio/visual elements may be incorporated to any of the symbols 120 within any of the plurality of frames 118 in order to further vary the gameplay on the game machine 10.

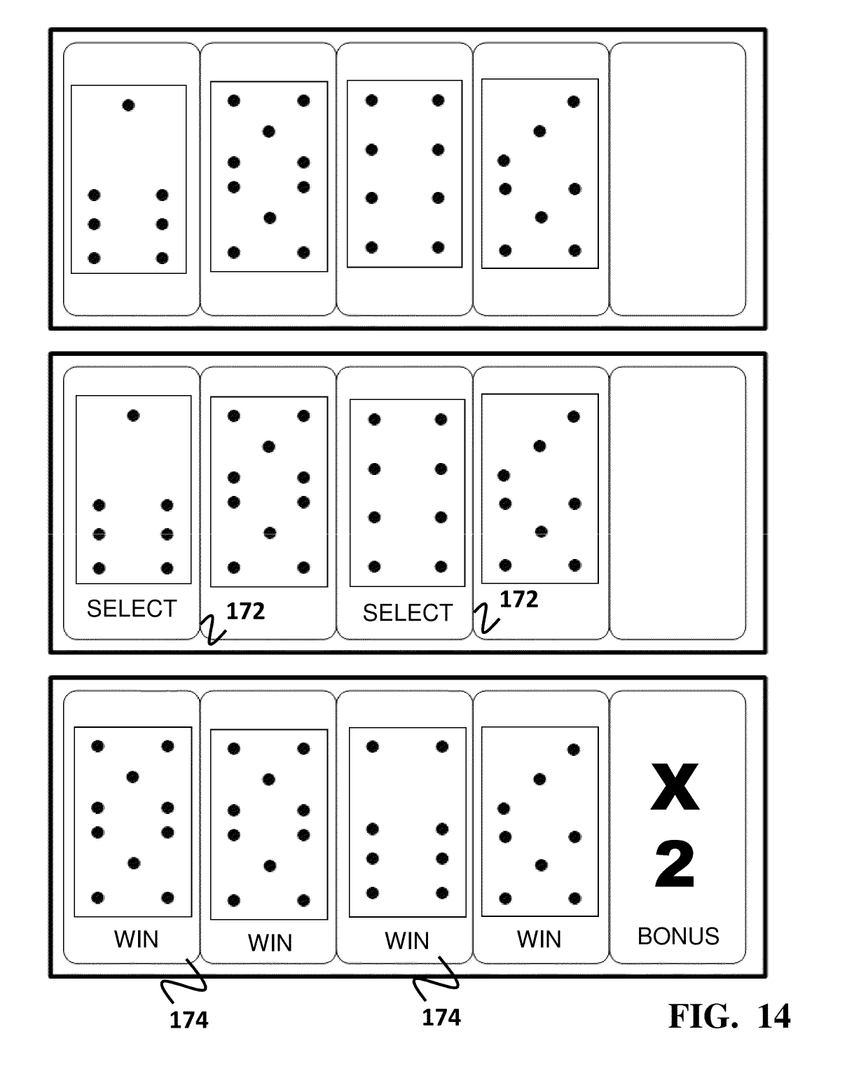

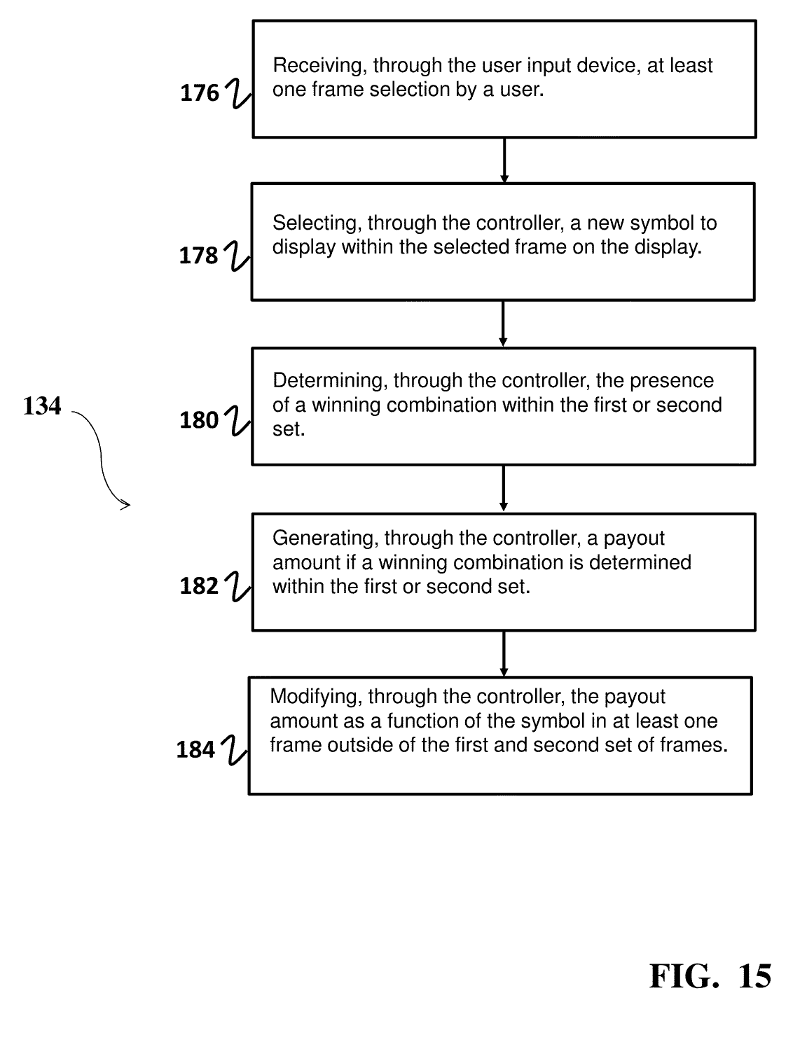

FIG. 14 is a representation of multiple game screens showing an alternate embodiment of game 80. In this embodiment the game machine 10 further includes a user input device 14 configured to allow a user to select the frames on the display. In this embodiment the gaming controller 16 is further configured to receive at least one frame selection 172 by a user through the user input device 14. Then, the gaming controller 16 is further configured to select a new symbol 174 to display within the selected frame on the display device 12. Here in FIG. 14, the middle screen image shows the selected frames as the first and third frame within the plurality of frames 118. Once the new symbols are within the selected frames 172, the gaming controller 16 determines the presence of a winning combination 122 within the first set of frames 124 and second set of frames 126. The gaming controller 16 then generates a payout amount if a winning combination is determined within the first set of frames 124 and second set of frames 126. Finally, the gaming controller then modifies the payout amount as a function of the symbol 130 in at least one frame outside of the first and second set of frames.

In another embodiment, as shown through a flowchart in FIG. 13, is the method 134, which demonstrates a method of playing a game machine 10 further including the user input device 14 configured to allow a user to select the frames 172 on the display device 12. First, the method 134 further includes the steps of receiving 176, through the user input device, at least one frame selection 172 by a user. Next, the game controller selects 178 a new symbol to display within the selected frame 172 on the display device 12. Next, the gaming controller determines 180 the presence of a winning combination 122 within the first set of frames 124 and second set of frames 126. Next, gaming controller 16 then generates 182 a payout amount if a winning combination is determined within the first set of frames 124 and second set of frames 126. Finally, the gaming controller 16 then modifies 184 the payout amount as a function of the symbol 130 in at least one frame outside of the first and second set of frames. This embodiment allows for a video-poker interfaces that would allow a player to further interact with the game machine 10 and attempt to generate various tile pairs 116 during gameplay. This level of interaction increases game variability for a player.

In another embodiment, the game machine further includes a credit controller 62, wherein the payout amount is based on credit input by a player through the credit controller 62 and the winning combination 122 determined within the first set of frames 124 and second set of frames 126. This embodiment would incorporate increased payout amounts for players that made larger initial wagers prior to initiating their gaming session on the gaming machine 10.

Various additional embodiments vary the payout amounts according to certain outcomes or inputs by the player of the game machine 10. In another embodiment, the payout amount is based on the total winning combination 122 of both the first set of frames 124 and second set of frames 126. Another embodiment bases the payout amount on the credit input through the credit controller 62 and the symbol on display within each frame on the display device 12. This would allow for additional payout amounts that not only account for the presence of various winning combinations 122 but also take into account the particular Pai Gow domino tile 114 that is present within each frame on the display device. Finally, in another embodiment within the present disclosure, the payout amount is based on the credit input through the credit controller 62 as well as both of the winning combinations 122 within the first set of frames 124 and the second set of frames 126 reaching a specified amount.

### Stand-Alone Gaming Machines

As shown in FIG. 1, any of the above described embodiments for use on electronic display gaming machines may be incorporated into a stand-alone gaming machine 10 provided with a single display unit 12. In this implementation of games according to the disclosure, both the main games and feature games (if offered) are displayed on the single display unit.

Stand-Alone Gaming Machines with Secondary Display Unit

In a further preferred embodiment within the disclosure, as shown in FIG. 1, a stand-alone gaming machine 10 is provided with a secondary display unit 58 as well as a first display unit 54. In this embodiment the main game played on the primary display unit may take the form of either the first or second preferred embodiments described above. It is then a triggering event in the main game which offers a player a feature game as described in the third preferred embodiment above.

### Elements of the Embodiments Generally

Exemplary embodiments of these systems and methods are described above in detail. The systems and methods are not limited to the specific embodiments described herein, but rather, components of the systems and/or steps of the methods may be utilized independently and separately from other components and/or steps described herein. For example, the systems may also be used in combination with other systems and methods, and is not limited to practice with only the system and method as described herein.

The gaming controller 16 and likewise any computing device, or computer, such as described herein, may include at least one or more processors or processing units and a system memory. The gaming controller may typically also include at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the various embodiments.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspects and features of the present invention may be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Although specific features of various embodiments of the invention may be shown in some drawings and not in others, this is for convenience only. In accordance with the principles of the invention, any feature of a drawing may be referenced and/or claimed in combination with any feature of any other drawing.

What is claimed is:

1. A game machine comprising:
a display configured to display a plurality of frames; and
a controller in communication with the display, the controller configured to:
select at least one symbol to display within each frame on the display;
determine the presence of a winning combination of symbols between a first set of frames;
determine the presence of a winning combination of symbols between a second set of frames;
generate a payout amount if a winning combination is determined within the first or second set; and
modify the payout amount as a function of the symbol in at least another one of the frames.

2. The game machine of claim 1, wherein the symbols selected for display within the first set of frames are selected from a first predefined group.

3. The game machine of claim 2, wherein the symbols selected for display within the second set of frames are selected from a second predefined group.

4. The game machine of claim 3, wherein the symbols selected for display outside of the first and second set of frames are selected from a third predefined group.

5. The game machine of claim 4, wherein the first predefined group and the second predefined group are the same.

6. The game machine of claim 2, wherein the first predefined group is at least one set of Pai Gow domino tiles.

7. The game machine of claim 6, wherein a winning combination is at least one of these pairs of Pai Gow domino tiles:
2/4 with a 1/2 tile;
6/6 with a 6/6 tile;
1/1 with a 1/1 tile;
4/4 with a 4/4 tile;
1/3 with a 1/3 tile;
5/5 with a 5/5 tile;
3/3 with a 3/3 tile;
2/2 with a 2/2 tile;
5/6 with a 5/6 tile;
4/6 with a 4/6 tile;
1/6 with a 1/6 tile;
1/5 with a 1/5 tile;
4/5 with a 3/6 tile;
2/6 with a 3/5 tile;
3/4 with a 2/5 tile; or
2/3 with a 1/4 tile.

8. The game machine of claim 1, wherein the first and second set of frames comprise a playing field, the controller configured to:
display at least two additional sets of frames as a second playing field on the display;
determine the presence of a winning combination in either the first or second set of frames as winning combination within the first playing field;
determine the presence of a winning combination within either of the two additional set of frames as a winning combination within the second playing field;
generate a payout amount if a winning combination is determined within the first or second playing field; and
modify the payout amount as a function of a symbol in at least one other frame outside of the first and second playing fields.

9. The game machine of claim 1, wherein the first set of frames comprises a first playing field and the second set of frames comprises a second playing field, the controller configured to:
display at least one additional frame within each playing field;
determine the presence of a winning combination within the first playing field;
determine the presence of a winning combination within the second playing field;
generate a payout amount if a winning combination is determined within the first or second playing field; and
modify the payout amount as a function of a symbol in at least one other frame outside of the first and second playing fields.

10. The game machine of claim 1, wherein the modification of the payout amount includes adding to, subtracting from, dividing, and/or multiplying the payout amount.

11. The game machine of claim 1, wherein the winning combination consists of a completed image between the frames within either the first or second set of frames.

12. The game machine of claim 1, wherein the winning combination consists of a total amount between the frames within the first or second set of frames.

13. The game machine of claim 1, wherein the winning combination consists of corresponding symbols between the frames within the first or second set of frames.

14. The game machine of claim 1, wherein the winning combination consists of corresponding colors between the frames within the first or second set of frames.

15. The game machine of claim 1, the game machine further including a user input device configured to allow a user to select the frames on the display, the controller further configured to:
receive at least one frame selection, through the input device, by a user;
select a new symbol to display within the selected frame on the display;
determine the presence of a winning combination within the first and second set of frames;
generate a payout amount if a winning combination is determined within the first or second set; and
modify the payout amount as a function of the symbol in at least one frame outside of the first and second set of frames.

16. The game machine of claim 1, the game machine further including a credit controller, wherein the payout amount is based on credit input through the credit controller and the winning combination determined in the first or second set of frames.

17. The game machine of claim 16, wherein the payout amount is based on the winning combination of both the first and second set of frames.

18. The game machine of claim 17, wherein the payout amount is based on the credit input through the credit controller and the symbol on display within each frame on the display.

19. The game machine of claim 16, wherein the payout amount is based on the credit input through the credit controller, the winning combination determined in the first set, and the winning combination determined in the second set reaching a specified numerical amount.

20. A method of playing a game machine including a display and a controller in communication with the display, the display configured to display a plurality of frames, each frame configured to display a symbol, the method including the steps of:
selecting, through the controller, at least one symbol to display within each frame on the display;
determining, through the controller, the presence of a winning combination of symbols between a first set of frames;
determining, through the controller, the presence of a winning combination of symbols between a second set of frames;
generating, through the controller, a payout amount if a winning combination is determined within the first or second set; and
modifying, through the controller, the payout amount as a function of the symbol in at least one frame outside of the first and second set of frames.

21. The method of claim 20, wherein the symbols selected for display within the first set of frames are selected from a first predefined group.

22. The method of claim 21, wherein the symbols selected for display within the second set of frames are selected from a second predefined group.

23. The method of claim 22, wherein the symbols selected for display outside of the first and second set of frames are selected from a third predefined group.

24. The method of claim 23, wherein the first predefined group and the second predefined group are the same.

25. The method of claim 21, wherein the first predefined group is at least one set of Pai Gow domino tiles.

26. The method of claim 25, wherein the winning combination is at least one of these pairs of Pai Gow domino tiles:
2/4 with a 1/2 tile;
6/6 with a 6/6 tile;
1/1 with a 1/1 tile;
4/4 with a 4/4 tile;
1/3 with a 1/3 tile;
5/5 with a 5/5 tile;
3/3 with a 3/3 tile;
2/2 with a 2/2 tile;
5/6 with a 5/6 tile;
4/6 with a 4/6 tile;
1/6 with a 1/6 tile;
1/5 with a 1/5 tile;
4/5 with a 3/6 tile;
2/6 with a 3/5 tile;
3/4 with a 2/5 tile; or
2/3 with a 1/4 tile.

27. The method of claim 20, wherein the first and second set of frames comprise a playing field, the method further including the steps of:
displaying, on the display, at least two additional set of frames as a second playing field;
determining, through the controller, the presence of a winning combination in either the first or second set of frames as winning combination within the first playing field;
determining, through the controller, the presence of a winning combination within either of the two additional set of frames as a winning combination within the second playing field;
generating, through the controller, a payout amount if a winning combination is determined within the first or second playing field; and
modifying, through the controller, the payout amount as a function of a symbol in at least one other frame outside of the first and second playing fields.

28. The method of claim 20, wherein the first set of frames comprises a first playing field and the second set of frames comprises a second playing field, the method further including the steps of:
displaying, on the display, at least one additional frame within each playing field;
determining, through the controller, the presence of a winning combination within the first playing field;
determining, through the controller, the presence of a winning combination within the second playing field;
generating, through the controller, a payout amount if a winning combination is determined within the first or second playing field; and
modifying, through the controller, the payout amount as a function of a symbol in at least one other frame outside of the first and second playing fields.

29. The method of claim 20, wherein the modification of the payout amount step includes adding to, subtracting from, dividing, and/or multiplying the payout amount.

30. The method of claim 20, wherein the winning combination consists of a completed image between the frames within either the first or second set of frames.

31. The method of claim 20, wherein the winning combination consists of a total amount between the frames within the first or second set of frames.

32. The method of claim 20, wherein the winning combination consists of corresponding symbols between the frames within the first or second set of frames.

33. The method of claim 20, wherein the winning combination consists of corresponding colors between the frames within the first or second set of frames.

34. The method of claim 20, the game machine further including a user input device configured to allow a user to select the frames on the display, the method further including the steps of:
receiving, through the user input device, at least one frame selection by a user;
selecting, through the controller, a new symbol to display within the selected frame on the display;
determining, through the controller, the presence of a winning combination within the first or second set;
generating, through the controller, a payout amount if a winning combination is determined within the first or second set; and
modifying, through the controller, the payout amount as a function of the symbol in at least one frame outside of the first and second set of frames.

35. The method of claim 20, the game machine further including a credit controller, wherein the payout amount is based on credit input through the credit controller, the method further including the step of determining, through the controller, the presence of a winning combination in the first or second set of frames.

36. The method of claim 25, wherein the payout amount is based on the winning combination of both the first and second set of frames.

37. The method of claim 35, wherein the payout amount is based on the credit input through the credit controller and the symbol on display within each frame on the display.

38. The method of claim 35, wherein the payout amount is based on the credit input through the credit controller, the winning combination determined in the first set, and the winning combination determined in the second set reaching a specified numerical amount.

39. A non-transitory information recording medium containing a computer readable program that functions as a game machine comprising:
a display configured to display a plurality of frames; and
a controller in communication with the display, the controller configured to:
select at least one symbol to display within each frame on the display;
determine the presence of a winning combination of symbols between a first set of frames;
determine the presence of a winning combination of symbols between a second set of frames;
generate a payout amount if a winning combination is determined within the first or second set; and
modify the payout amount as a function of the symbol in at least another one of the frames.
